(19) United States
(12) Patent Application Publication
(10) Pub. No.: US 2018/0299970 A1
(43) Pub. Date: Oct. 18, 2018

(54) MOTION DETECTION METHOD AND ELECTRONIC DEVICE SUPPORTING THE SAME

(71) Applicant: Samsung Electronics Co., Ltd, Suwon-si (KR)

(72) Inventors: Sunggyu KAM, Suwon-si (KR); Jinhyeong LEE, Gimhae-si (KR)

(21) Appl. No.: 15/956,530

(22) Filed: Apr. 18, 2018

(30) Foreign Application Priority Data
Apr. 18, 2017 (KR) 10-2017-0049630

(51) Int. Cl. G06F 3/038; G06F 1/16

(52) U.S. Cl. CPC G06F 3/038; G06F 2200/1637; G06F 2200/1636; G06F 1/1626

(57) ABSTRACT

Disclosed is a motion detection method and electronic device supporting the same. The electronic device may include: a sensor module including a motion sensor configured to detect motion on the electronic device; a memory; and a processor. The processor may be configured to: receive an output signal from the motion sensor; obtain first signal data from the received output signal; compute average rates of change between first values of the first signal data; obtain second values by converting the computed average rates of change into absolute values; and identify characteristics of the motion based on the obtained second values. Various embodiments are possible.

### CROSS-REFERENCE TO RELATED APPLICATION(S)

This application is based on and claims priority under 35 U.S.C. § 119 to Patent Application No. 10-2017-0049630 filed on Apr. 18, 2017 in the Korean Intellectual Property Office, the disclosure of which is incorporated herein by reference in its entirety.

### TECHNICAL FIELD

Various embodiments of the present disclosure relate to a motion detection method and an electronic device supporting the same.

### BACKGROUND

Recently, electronic devices are equipped with various sensors to provide various functions. The sensors mounted on the electronic devices enable the users to utilize the electronic devices in a more convenient way. Such an electronic device may be equipped with various sensors including an image sensor for photographing a target object and a motion sensor for sensing movement of the electronic device. Motion sensors may include a gyro sensor and an acceleration sensor, and may sense the rotation of the electronic device or the impact (tap, knock, or click) applied to the electronic device from the outside.

The electronic device may apply the rotation or external impact detected by the motion sensor to various application programs.

Existing techniques utilizing a motion sensor to detect external impacts are based on data obtained from the motion sensor in static situations and thus may be unsuitable for real-life environments with many movements. Even in a static situation, it may be difficult to detect minute impacts occurring outside the electronic device by using such existing techniques.

### SUMMARY

Aspects of the present disclosure are to address at least the above mentioned problems and/or disadvantages and to provide at least the advantages described below. Accordingly, an aspect of the present disclosure is to provide a method of detecting motion even in a dynamic situation and an electronic device supporting the method.

In accordance with an aspect of the present disclosure, an electronic device is provided. The electronic device may include: a sensor module including a motion sensor configured to detect motion on the electronic device; a memory; and a processor. The processor may be configured to: receive an output signal from the motion sensor; obtain first signal data from the received output signal; compute average rates of change between first values of the first signal data; obtain second values by converting the computed average rates of change into absolute values; and identify characteristics of the motion based on the obtained second values.

In accordance with another aspect of the present disclosure, there is provided a method of motion detection for an electronic device. The method may include: obtaining first signal data from an output signal of a motion sensor having sensed motion on the electronic device; computing average rates of change between first values of the first signal data; obtaining second values by converting the computed average rates of change into absolute values; and identifying characteristics of the motion based on the obtained second values.

In accordance with another aspect of the present disclosure, there is provided a computer-readable storage medium storing a program that, when executed, causes the processor of an electronic device to: obtain first signal data from an output signal of a motion sensor having sensed motion on the electronic device; compute average rates of change between first values of the first signal data; obtain second values by converting the computed average rates of change into absolute values; and identify characteristics of the motion based on the obtained second values.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document. Those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment including electronic devices according to various embodiments;

FIG. 2 illustrates a block diagram of an electronic device according to various embodiments;

FIG. 3 illustrates a block diagram of program modules according to various embodiments;

FIGS. 4A and 4B illustrate motion detection on the electronic device and data corresponding to the detected motion according to various embodiments;

FIG. 5 illustrates a flowchart of a procedure for motion detection according to various embodiments;

FIG. 6A depicts data corresponding to a detected motion according to various embodiments;

FIG. 6B depicts data representing the result of conversion applied to the data shown in FIG. 6A;

FIG. 7 illustrates a flowchart of a motion detection procedure performed by the electronic device according to various embodiments;

FIG. 8A depicts data corresponding to motion detected by the electronic device according to various embodiments;

FIG. 8B depicts data representing the result of conversion applied to the data shown in FIG. 8A;

FIG. 9A depicts data corresponding to motion detected by the electronic device according to various embodiments;

FIG. 9B depicts data representing the result of conversion applied to the data shown in FIG. 9A;

FIGS. 10A and 10B depict data corresponding to motion detected by the electronic device according to various embodiments;

FIGS. 11A and 11B depict data corresponding to motion detected by the electronic device according to various embodiments;

FIG. 12 depicts data corresponding to motion detected by the electronic device according to various embodiments;

FIGS. 13A and 13B illustrate motion detection on the electronic device according to various embodiments;

FIGS. 14A and 14B illustrate motion detection on the electronic device according to various embodiments; and

FIGS. 15A and 15B illustrate motion detection on the electronic device according to various embodiments.

### DETAILED DESCRIPTION

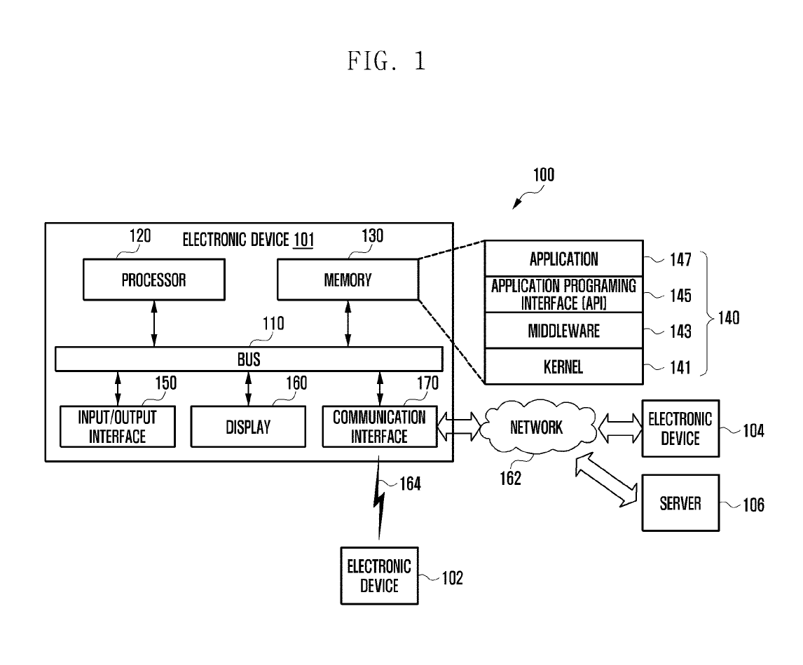

FIGS. 1 through 15B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific embodiments, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

FIG. 1 illustrates a network environment including an electronic device according to various embodiments of the present disclosure.

An electronic device 101 within a network environment 100, according to various embodiments, will be described with reference to FIG. 1.

Referring to FIG. 1, the electronic device 101 may include a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 110 to 170 and delivers a communication (e.g., a control message and/or data) between the components 110 to 170.

The processor 120 may include one or more of a Central Processing Unit (CPU), an Application Processor (AP), and a Communication Processor (CP). The processor 120 may carry out, for example, calculation or data processing relating to control and/or communication of at least one other component of the electronic device 101.

The memory 130 may include a volatile memory and/or a non-volatile memory. The memory 130 may store, for example, commands or data relevant to at least one other component of the electronic device 101. According to an embodiment of the present disclosure, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources.

The middleware 143, for example, may serve as an intermediary for allowing the API 145 or the application programs 147 to communicate with the kernel 141 to exchange data.

Also, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the application programs 147 control functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a Liquid Crystal Display (LCD), a Light-Emitting Diode (LED) display, an Organic Light-Emitting Diode (OLED) display, an active matrix OLED (AMOLED), a MicroElectroMechanical Systems (MEMS) display, and an electronic paper display. The display 160 may display, for example, various types of contents (e.g., text, images, videos, icons, or symbols) to users. The display 160 may include a touch screen, and may receive, for example, a touch, gesture, proximity, or hovering input using an electronic pen or a user's body part.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106).

The wireless communication may include cellular communication using at least one of, for example, Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), or the like.

According to one embodiment, the wireless communication may include, for example, short range communication 164. The short range communication 164 may include at least one of, for example, Wi-Fi, Light Fidelity (Li-Fi), Wireless Gigabit alliance (WiGig), Bluetooth, Bluetooth Low Energy (BLE), Zigbee, Near Field Communication (NFC), magnetic secure transmission, Radio Frequency (RF), or a Body Area Network (BAN).

According to one embodiment, the wireless communication may include Global Navigation Satellite System (GNSS). The GNSS may include, for example, Global Positioning System (GPS), Global Navigation satellite system (Glonass), Beidou Navigation satellite system (hereinafter, referred to as “Beidou”) or Galileo, and the European global satellite-based navigation system. Hereinafter, in the present disclosure, the “GPS” may be interchangeably used with the “GNSS”.

The wired communication may include, for example, at least one of a Universal Serial Bus (USB), a High Definition Multimedia Interface (HDMI), Recommended Standard 232 (RS-232), and a Plain Old Telephone Service (POTS).

The network 162 may include at least one of a telecommunication network such as a computer network (e.g., a LAN or a WAN), the Internet, and a telephone network.

Each of the first external electronic device 102 and second external electronic device 104 may be of a type identical to or different from that of the electronic device 101. According to an embodiment of the present disclosure, the server 106 may include a group of one or more servers.

According to various embodiments of the present disclosure, all or some of the operations performed in the electronic device 101 may be executed in another electronic device or a plurality of electronic devices (e.g., the electronic devices 102 and 104 or the server 106). According to an embodiment of the present disclosure, when the electronic device 101 has to perform some functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

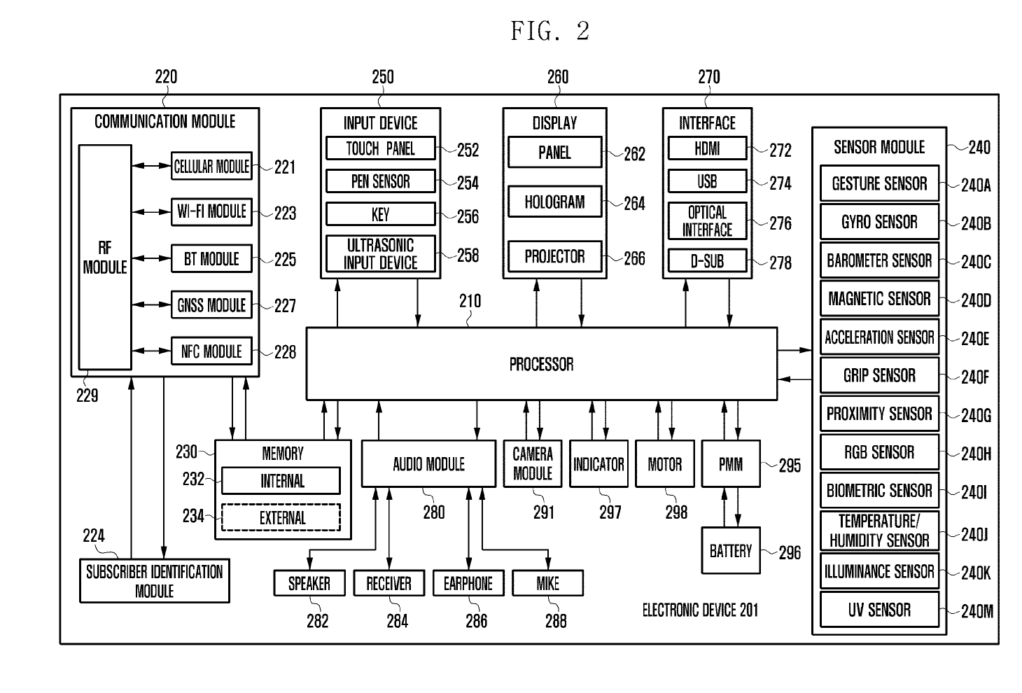

FIG. 2 illustrates a block diagram of an electronic device according to various embodiments of the present disclosure.

The electronic device 201 may include, for example, all or a part of the electronic device 101 shown in FIG. 1. The electronic device 201 may include one or more processors 210 (e.g., Application Processors (AP)), a communication module 220, a Subscriber Identification Module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, and perform processing of various pieces of data and calculations. The processor 210 may be embodied as, for example, a System on Chip (SoC). According to an embodiment of the present disclosure, the processor 210 may further include a Graphic Processing Unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The communication module 220 may have a configuration equal or similar to that of the communication interface 170 of FIG. 1. The communication module 220 may include, for example, a cellular module 221, a Wi-Fi module 223, a BT module 225, a GNSS module 227 (e.g., a GPS module 227, a Glonass module, a Beidou module, or a Galileo module), an NFC module 228, and a Radio Frequency (RF) module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using the subscriber identification module 224 (for example, the SIM card). According to an embodiment of the present disclosure, the cellular module 221 may perform at least some of the functions that the processor 210 may provide. According to an embodiment of the present disclosure, the cellular module 221 may include a communication processor (CP).

According to an embodiment of the present disclosure, at least some (e.g., two or more) of the cellular module 221, the Wi-Fi module 223, the BT module 225, the GNSS module 227, and the NFC module 228 may be included in one Integrated Chip (IC) or IC package.

The RF module 229, for example, may transmit/receive a communication signal (e.g., an RF signal). The RF module 229 may include, for example, a transceiver, a Power Amplifier Module (PAM), a frequency filter, a Low Noise Amplifier (LNA), and an antenna. According to another embodiment of the present disclosure, at least one of the cellular module 221, the Wi-Fi module 223, the BT module 225, the GNSS module 227, and the NFC module 228 may transmit/receive an RF signal through a separate RF module.

The subscriber identification module 224 may include, for example, a card including a subscriber identity module and/or an embedded SIM (eSIM), and may contain unique identification information (e.g., an Integrated Circuit Card Identifier (ICCID)) or subscriber information (e.g., an International Mobile Subscriber Identity (IMSI)).

The memory 230 (e.g., the memory 130) may include, for example, an internal memory 232 or an external memory 234. The internal memory 232 may include at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a MultiMediaCard (MMC), a memory stick, or the like. The external memory 234 may be functionally and/or physically connected to the electronic device 201 through various interfaces.

The sensor module 240, for example, may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 2401, a temperature/humidity sensor 240J, an illuminance sensor 240K, and a Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris scan sensor, and/or a finger scan sensor. The sensor module 240 may further include a control circuit for controlling one or more sensors included therein. According to an embodiment of the present disclosure, the electronic device 201 may further include a processor configured to control the sensor module 240, as a part of the processor 210 or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, a projector 266, and/or a control circuit for controlling the aforementioned elements.

The panel 262 may be implemented to be flexible, transparent, or wearable. The panel 262 and the touch panel 252 may be integrated into one or more modules. According to one embodiment, the panel 262 may include a pressure sensor (or a force sensor) for measuring an intensity of pressure on a user's touch. The pressure sensor may be integrated into the touch panel 252 or may be implemented with one or more sensors separate from the touch panel 252.

The hologram device 264 may display a stereoscopic image in a space using a light interference phenomenon. The projector 266 may project light onto a screen so as to display an image. The screen may be arranged inside or outside the electronic device 201.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to an embodiment of the present disclosure, the camera module 291 may include one or more image sensors (e.g., a front sensor or a back sensor), a lens, an Image Signal Processor (ISP) or a flash (e.g., LED or xenon lamp).

The power management module 295 may manage, for example, power of the electronic device 201. According to an embodiment of the present disclosure, the power management module 295 may include a Power Management Integrated Circuit (PMIC), a charger Integrated Circuit (IC), or a battery gauge (or a fuel gauge). The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a specific state of the electronic device 201 or a portion thereof (e.g., a processor 210), such as a booting state, a message state, a charging state, and the like. The motor 298 may convert an electrical signal into a mechanical vibration and may generate vibration, a haptic effect, and the like.

For example, the electronic device 201 may include a mobile TV supporting device (for example, a GPU) for processing media data according to the standards of digital multimedia broadcasting (DMB), digital video broadcasting (DVB), MediaFlo™, or the like.

Each of the elements described in the present disclosure may be configured with one or more components, and the names of the elements may be changed according to the type of the electronic device. According to various embodiments, some elements of the electronic device (for example, the electronic device 101, 201) may be omitted or other additional elements may be added. Furthermore, some of the elements may be combined with each other so as to form one entity, and the functions of the elements may be performed in the same manner as before being combined.

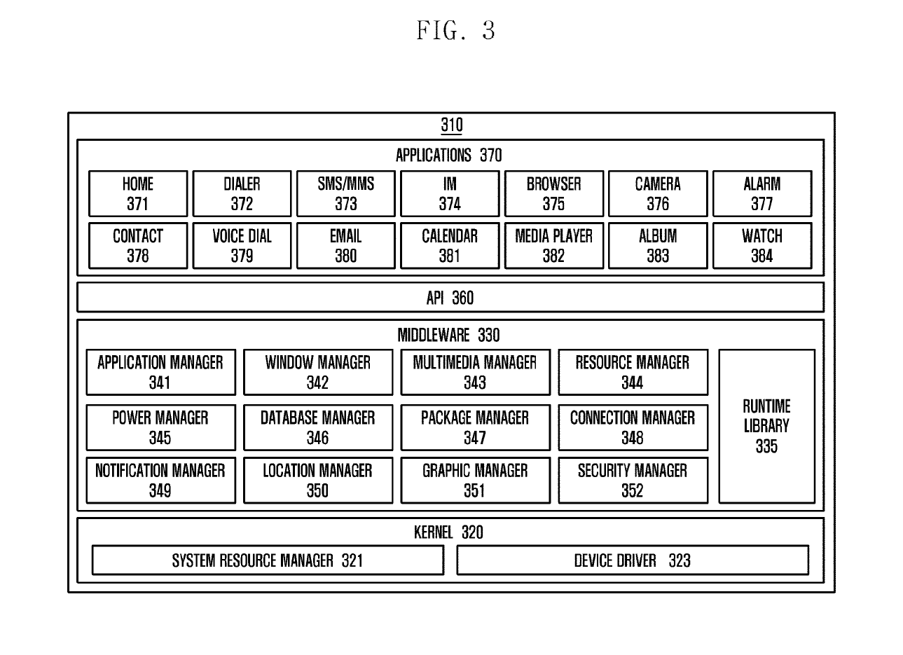

FIG. 3 illustrates a block diagram of a program module according to various embodiments of the present disclosure.

According to an embodiment of the present disclosure, the program module 310 (e.g., the program 140) may include an Operating System (OS) for controlling resources related to the electronic device (e.g., the electronic device 101) and/or various applications (e.g., the application programs 147) executed in the operating system. The operating system may be, for example, Android™, iOS™, Windows™, Symbian™, Tizen™, Bada™, or the like.

The program module 310 may include a kernel 320, middleware 330, an API 360, and/or applications 370. At least some of the program module 310 may be preloaded on an electronic device, or may be downloaded from an external electronic device (e.g., the electronic device 102 or 104, or the server 106). The kernel 320 (e.g., the kernel 141) may include, for example, a system resource manager 321 and/or a device driver 323. The system resource manager 321 may control, allocate, or collect system resources. According to an embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

For example, the middleware 330 may provide a function used in common by the applications 370, or may provide various functions to the applications 370 through the API 360 so as to enable the applications 370 to efficiently use the limited system resources in the electronic device. According to an embodiment of the present disclosure, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, the functionality for an arithmetic function, or the like.

The application manager 341 may manage, for example, a life cycle of at least one of the applications 370. The window manager 342 may manage Graphical User Interface (GUI) resources used by a screen. The multimedia manager 343 may recognize a format used for reproduction of various media files, and may perform encoding or decoding of a media file by using a codec suitable for the corresponding format. The resource manager 344 may manage resources of a source code, a memory, and a storage space of at least one of the applications 370.

The power manager 345 may manage, for example, battery capacity, temperature, or power, and may determine or provide power information used for the operation of the electronic device (101, 201) based on corresponding information. According to an embodiment, the power manager 345 may operate in conjunction with a Basic Input/Output System (BIOS).

The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as an arrival message, promise, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions used for system security, user authentication, or the like. According to an embodiment of the present disclosure, when the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (e.g., the application programs 147) may include, for example, one or more applications which may provide functions such as a home 371, a dialer 372, an SMS/MMS 373, an Instant Message (IM) 374, a browser 375, a camera 376, an alarm 377, contacts 378, a voice dial 379, an email 380, a calendar 381, a media player 382, an album 383, and a watch 384. The applications 370 may include a health care (e.g., measuring exercise quantity or blood sugar), or environment information (e.g., providing atmospheric pressure, humidity, or temperature information) providing application, a payment application, a card registration application, a card company application, or a bank application.

According to an embodiment of the present disclosure, the applications 370 may include an application (hereinafter, referred to as an “information exchange application” for convenience of description) that supports exchanging information between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may include a function of transferring, to the external electronic device (e.g., the electronic device 102 or 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

The device management application may manage (e.g., install, delete, or update), for example, at least one function of an external electronic device (e.g., the electronic device 102 or 104) communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to an embodiment of the present disclosure, the applications 370 may include applications (e.g., a health care application of a mobile medical appliance or the like) designated according to an external electronic device (e.g., attributes of the electronic device 102 or 104). According to an embodiment of the present disclosure, the applications 370 may include an application received from an external electronic device (e.g., the server 106, or the electronic device 102 or 104). According to an embodiment of the present disclosure, the applications 370 may include a preloaded application or a third party application that may be downloaded from a server. The names of the components of the program module 310 of the illustrated embodiment of the present disclosure may change according to the type of operating system.

According to various embodiments, at least a part of the programming module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter. According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable recoding media may be, for example, the memory 130.

The computer readable recording medium may include a hard disk, a floppy disk, a magnetic medium (e.g., a magnetic tape), an optical storage medium (e.g., a Compact Disc-ROM (CD-ROM) or a Digital Versatile Disc (DVD), a magnetic-optic medium such as a floptical disc), an internal memory, or the like. The instruction may include a code created by a compiler or a code executable by an interpreter. The module or programming module according to various embodiments may further include at least one or more constitutional elements among the aforementioned constitutional elements, or may omit some of them, or may further include other constitutional elements. Operations performed by a module, programming module, or other constitutional elements according to various embodiments may be executed in a sequential, parallel, repetitive, or heuristic manner. Alternatively, at least some of the operations may be executed in a different order or may be omitted, or other operations may be added.

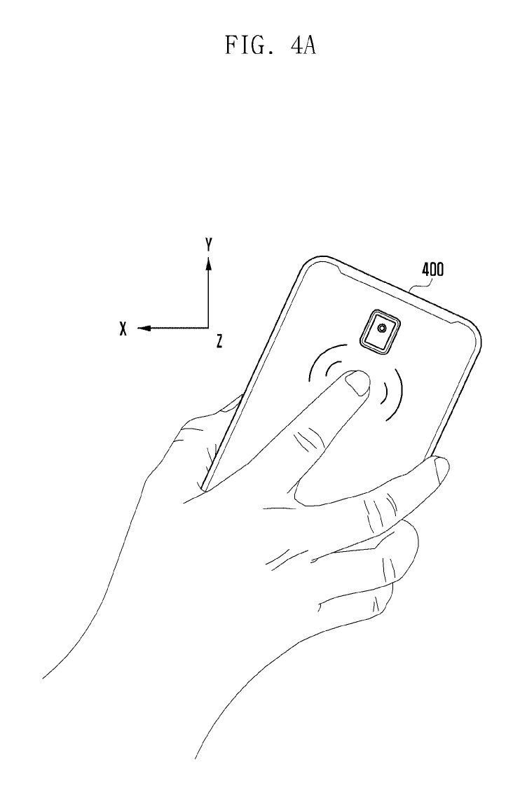

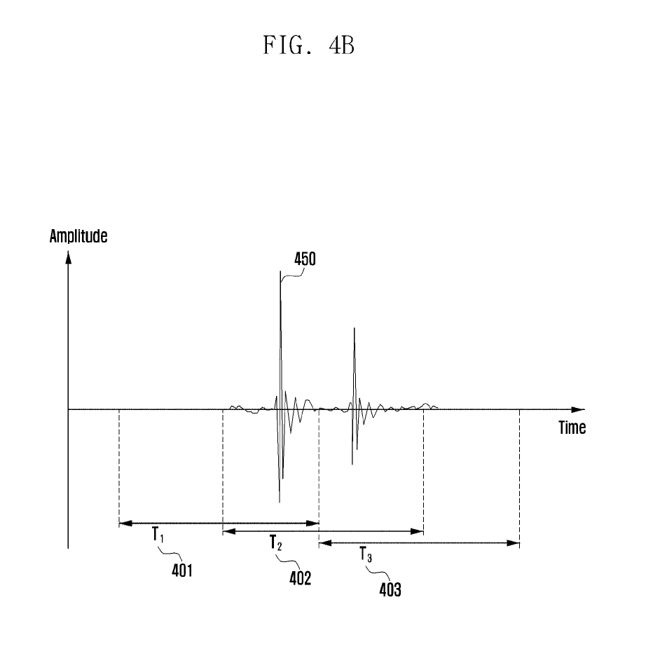

FIGS. 4A and 4B illustrate motion detection on the electronic device and data corresponding to the detected motion according to various embodiments.

The electronic device 400 may identify the characteristics of motion sensed by the motion sensor. Here, examples of motion may include a tap, a knock, and a click generating an impact on the electronic device 400, and may also include a change in the attitude of the electronic device 400 such as turning over.

The motion generating an impact on the electronic device 400 can be detected by an acceleration sensor among motion sensors. The acceleration sensor may include at least a portion of the acceleration sensor 240E of the sensor module 240 shown in FIG. 2. The acceleration sensor can represent the impact by data related to at least one of the X axis, Y axis, and Z axis). The X and Y axes are perpendicular to each other, and the Z axis is perpendicular to the X and Y axes.

The motion causing a change in the attitude of the electronic device 400 can be detected by a gyro sensor among motion sensors. The gyro sensor may include at least a portion of the gyro sensor 240B of the sensor module 240 shown in FIG. 2.

In one embodiment, the electronic device 400 can determine whether motion occurs based on data about one axis (e.g., Z axis).

The electronic device 400 may analyze noise components using data about another axis. In addition, the electronic device 400 may identify the detailed direction of the generated motion by utilizing data about the other axis.

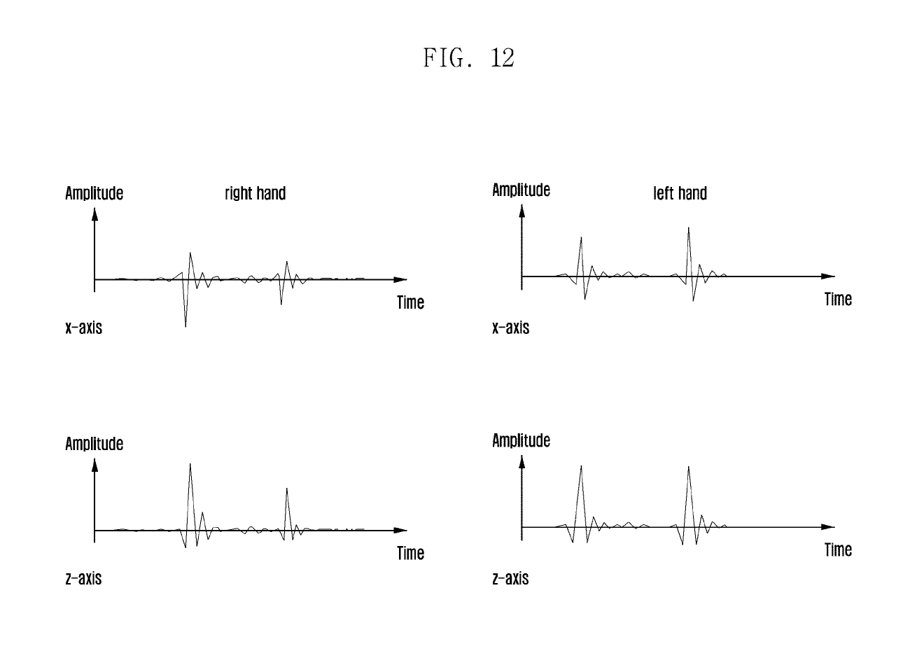

As shown in FIG. 4A, the user can grip the electronic device 400 with one hand. The user may apply motion to a portion of the electronic device 400 while gripping the electronic device 400 with one hand. For example, when motion is applied to a portion of the back of the electronic device 400 as shown in FIG. 4A, the acceleration sensor 240E of the electronic device 400 can produce impact data with respect to the axes at the same time or within a time error range. The electronic device 400 can receive Z-axis data having a value greater than that of other axis data from the acceleration sensor 240E. The electronic device 400 can determine whether the hand gripping the electronic device 400 is the right hand or the left hand on the basis of data of another axis (e.g., X axis) sensed in the same time duration when the Z-axis impact data is sensed. Determining whether the hand gripping the electronic device 400 is the right hand or the left hand is described in detail later with reference to FIG. 12.

In another embodiment, the electronic device 400 may identify omnidirectional motion by using acceleration vector values of two or more axes.

Hereinafter, various embodiments of the present disclosure are described with respect to one axis (e.g., Z axis) for the purpose of understanding.

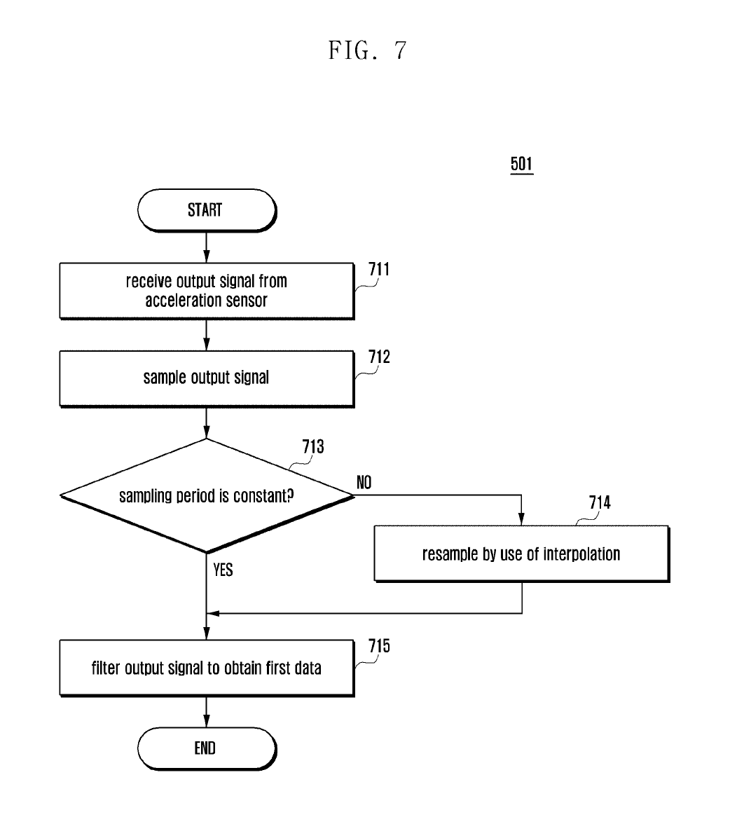

FIG. 4B depicts the data 450 in the time domain corresponding to the motion applied to the back of the electronic device 400. The data shown in FIG. 4B may be Z-axis data received from the acceleration sensor 240E in the situation shown in FIG. 4A. The data 450 in FIG. 4B may be filtered data. Filtering is described in detail later with reference to FIG. 7.

The data received from the acceleration sensor 240E may include one high amplitude and several residual amplitudes.

In one embodiment, the electronic device 400 can identify the motion by dividing and analyzing the data received from the acceleration sensor 240E in a specific unit of time. If the time interval for analyzing the data is short, high and residual amplitudes representing the motion on the received data may be biased at the beginning or end of the time interval. On the other hand, if the time interval is lengthened so that high and residual amplitudes are not biased at the beginning or end of the time interval, the response time may be delayed.

In various embodiments, the electronic device 400 may determine the motion by analyzing amplitudes detected during an overlap period between at least two analysis times. For example, as shown in FIG. 4B, the electronic device 400 may analyze the amplitudes of motion during the overlap period between analysis time T₁ (401) and subsequent analysis time T₂ (402). The electronic device 400 may also analyze the amplitudes of motion during the overlap period between analysis time T₂ (402) and subsequent analysis time T₃ (403).

As another example, if a detected amplitude is present at the end of analysis time T₂ (402), the electronic device 400 may analyze the amplitudes during analysis time T₃ (403) overlapping with analysis time T₂ (402).

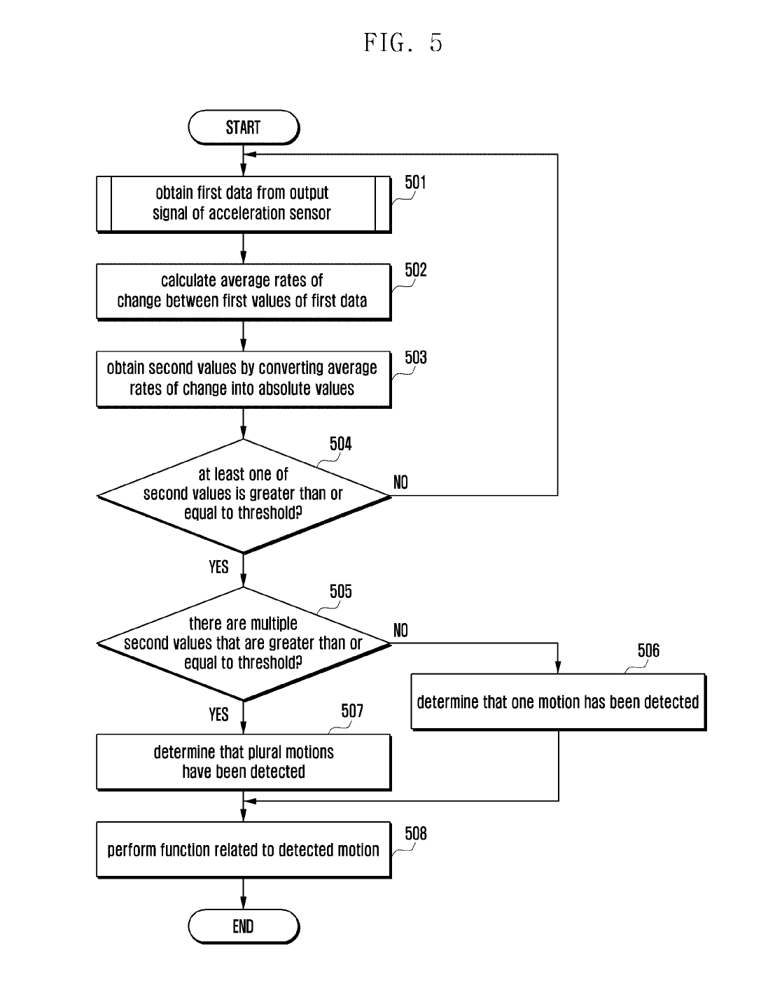

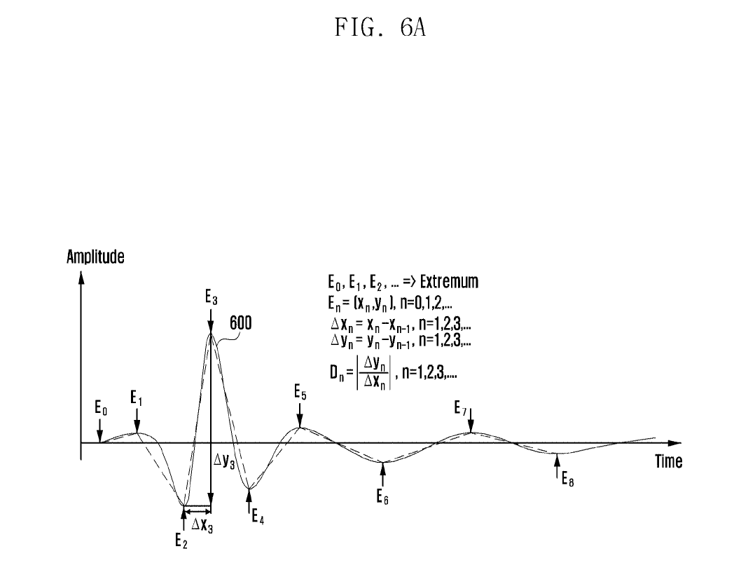

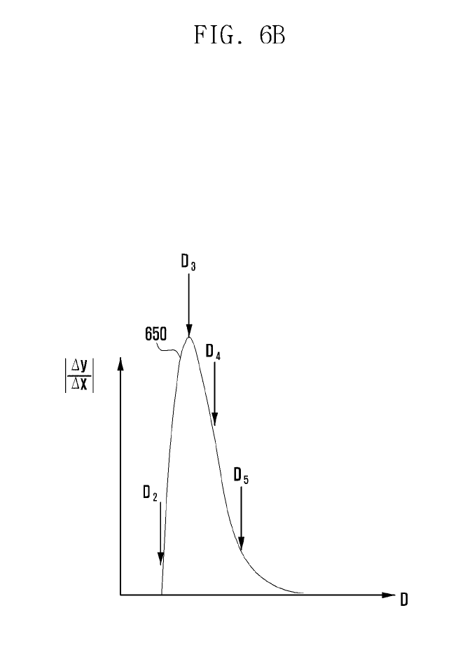

FIG. 5 illustrates a flowchart of a procedure for motion detection according to various embodiments. FIG. 6A depicts data corresponding to a detected motion according to various embodiments, and FIG. 6B depicts data representing the result of conversion applied to the data shown in FIG. 6A.

With reference to FIG. 5, at operation 501, the processor 120 (e.g., processor 120 or 210 of FIG. 1 or 2) of the electronic device 400 (e.g., electronic device 101 or 201 of FIG. 1 or 2) may receive an output signal from the acceleration sensor 240E among the motion sensors. The processor 120 may obtain first signal data from the received output signal. The first signal data may be data that has passed through a filter. The filter may be a high pass filter (HPF) or a band pass filter (BPF).

For ease of description, the first signal data may be represented in a graph form as indicated by a graph (first signal data) 600 of FIG. 6A. In FIG. 6A, the X-axis of the graph of FIG. 6A represents the time, and the Y-axis represents the amplitude.

At operation 502, the processor 120 may calculate the average rate of change between first values of the graph (first signal data) 600. The first value may include a value on the graph 600 corresponding to a point on the X axis. The first values may include values corresponding to inflection points, extreme values (maxima and minima) that are larger or smaller than nearby points, and values corresponding to critical points on the graph 600. In the flowing description, it is assumed that the first values are composed of extreme values that are larger or smaller than nearby points on the graph 600. As shown in FIG. 6A, the first values of the first signal data 600 may be represented by Eₙ (n=0, 1, 2, 3, . . . ). Since the first values are characterized by time and amplitude, for example, E₀ can be represented as (x₀, y₀), where x₀ means time and y₀ means amplitude.

The processor 120 may calculate the average rate of change between adjacent first values. The average rate of change is indicated by a dotted line in FIG. 6A, and may be computed using Equation 1 below.

$${E}_{n} ( {x}_{n} , {y}_{n} ) ( n = 0 , 1 , 2 , 3 , … ) \\ Δ {x}_{n} = {x}_{n} - {x}_{n - 1} ( n = 0 , 1 , 2 , 3 , … ) \\ Δ {y}_{n} = {y}_{n} - {y}_{n - 1} ( n = 0 , 1 , 2 , 3 , … ) \\ average rate of change = \frac{Δ {y}_{n}}{Δ {x}_{n}} ( n = 0 , 1 , 2 , 3 , … ) \qquad [ Equation 1 ]$$

At operation 503, the processor 120 may obtain second values by converting the calculated average rate of change into absolute values using Equation 2 below. In the following description, the second values are represented by Dₙ.

$${D}_{n} = \vert \frac{Δ {y}_{n}}{Δ {x}_{n}} \vert ( n = 0 , 1 , 2 , 3 , … ) \qquad [ Equation 2 ]$$

The graph 650 of the second values, which are absolute values of the average rate of change, can have a single peak as shown in FIG. 6B. In one embodiment, one peak may indicate one impact.

In various embodiments, the graph 650 of the second values may have a plurality of peaks according to the first values. The number of peaks may mean the number of values greater than nearby values among the second values.

In various embodiments, one peak may include a plurality of second values.

Since the first signal data 600 includes one high amplitude and several residual amplitudes, it can be seen that the absolute value of the average rate of change gradually decreases.

The processor 120 may extract features necessary to detect motion based on the obtained second values. Since Dₙ is related to Eₙ and Eₙ₋₁, the second values may be associated with the time corresponding to Eₙ and Eₙ₋₁ on the graph 650 of the second values Dₙ.

For example, the processor 120 can extract features such as the occurrence time of the maximum amplitude of the motion, the value corresponding to the maximum amplitude thereof, the duration of the vibration due to the motion, and the number of vibrations generated by the motion.

In FIG. 6B, the occurrence time of the maximum amplitude of the detected motion may be indicated by x₃ of E₃ associated with D₃ representing the maximum among the second values. The value corresponding to the maximum amplitude may be indicated by y₃ of E₃. The duration of the vibration due to the motion may be indicated by the sum of Δxₙ associated with the second values Dₙ belonging to one peak. The number of vibrations generated by the motion may be indicated by the number of first values.

At operation 504, the processor 120 may determine whether at least one of the second values is greater than or equal to a preset threshold. The threshold may be set differently according to the motion of the user. For example, the threshold for a user applying fine motion to the electronic device may be set to be smaller than that for a user applying a large motion. For example, in FIG. 6B, one second value (D₃) may be greater than the threshold.

Upon determining that at least one of the second values is greater than or equal to the threshold, at operation 505, the processor 120 may determine whether there are multiple peaks including a second value greater than or equal to the threshold.

Upon determining that there is one peak including a second value greater than or equal to the threshold (e.g., one peak including D₃ greater than the threshold), at operation 506, the processor 120 may determine that one motion has been detected. Then, at operation 508, the processor 120 may perform a function associated with the determined motion.

Upon determining that there are multiple peaks including a second value greater than or equal to the threshold, at operation 501, the processor 120 may determine that a plurality of motions have been detected. Then, at operation 508, the processor 120 may perform a function associated with the determined motions.

Upon determining that no second value is greater than or equal to the threshold at operation 504, the procedure returns to operation 501 at which the processor 120 may obtain first signal data from the acceleration sensor 240E.

FIG. 7 illustrates a flowchart of a motion detection procedure performed by the electronic device according to various embodiments. FIG. 7 may be a detailed flowchart for operation 501 in FIG. 5.

At operation 711, the processor 120 may receive an output signal from the acceleration sensor 240E.

At operation 712, the processor 120 may sample the received output signal.

At operation 713, the processor 120 may determine whether the sampling period of the output signal is constant based on the sampling result. In some cases, the processor 120 may be unable to periodically collect samples (e.g., output signals) from the acceleration sensor 240E owing to limitations of the acceleration sensor 240E or system. If the sampling period is not constant, this may affect the average rate of change and the accuracy of the analysis of the motion data in a short interval may be lowered.

Upon determining that the sampling period is constant at operation 713, at operation 715, the processor 120 may filter the output signal to obtain the first signal data.

Upon determining that the sampling period is not constant at operation 713, at operation 714, the processor 120 may resample the non-periodically sampled data at regular intervals by use of interpolation. Interpolation may refer to a technique of generating periodic data by estimating data based on non-periodically sampled data. As interpolation is a well-known technique, a detailed description thereof is omitted. Thereafter, at operation 715, the processor 120 may filter the output signal to obtain the first signal data.

In one embodiment, when motion is applied to the electronic device 400, the output signal from the acceleration sensor 240E may include high frequency components. On the other hand, the gravitational acceleration generated due to noise occurring in everyday life or the angle at which the electronic device 400 is gripped may include low frequency components. The electronic device 400 may apply a HPF or BPF to the output signal from the acceleration sensor 240E to remove noise and gravitational acceleration components. The cutoff frequency of the filter (e.g., 30 to 70 Hz) can be variably determined depending on the characteristics of the electronic device 400 and the acceleration sensor 240E. The type and characteristics of the filter may be different according to the characteristics of the electronic device 400 and the acceleration sensor 240E. In addition, the electronic device 400 may apply one or more filters in an overlapping manner. The electronic device 400 may apply the filter to the signal output from the acceleration sensor 240E at regular intervals according to the characteristics of the filter.

As described above, the motion detection method of the electronic device 400 according to various embodiments of the present disclosure may include: obtaining first signal data from an output signal of a motion sensor having sensed motion on the electronic device; computing average rates of change between first values of the first signal data; obtaining second values by converting the computed average rates of change into absolute values; and identifying characteristics of the motion based on the obtained second values.

In one embodiment, the motion detection method may further include performing a function related to the identified characteristics of the motion.

In one embodiment, the output signal of the motion sensor may include an output signal associated with one of one or more axes of an acceleration sensor.

In one embodiment, obtaining first signal data may include: sampling the output signal; determining whether the sampling period of the output signal is constant; resampling the output signal by use of interpolation if the sampling period is not constant; and filtering the resampled output signal to obtain the first signal data.

In one embodiment, obtaining first signal data may include filtering the sampled output signal to obtain the first signal data if the sampling period is constant.

In one embodiment, filtering the output signal may include filtering using at least one of a high pass filter and a band pass filter.

In one embodiment, the first values may include one of a relative maximum greater than nearby values and a relative minimum less than nearby values among the values of the first signal data.

In one embodiment, each first value may include a time value and an amplitude value.

In one embodiment, identifying characteristics of the motion may include determining the number of occurrences of motion on the basis of the number of second values that are a relative maximum greater than or equal to a preset threshold.

In one embodiment, if there are multiple second values that are a relative maximum greater than or equal to the threshold, identifying characteristics of the motion may include determining, if the difference between the times corresponding to those second values is within a preset duration, the directions of the motion, and determining that a plurality of motions have been detected if the directions are identical.

In one embodiment, determining the directions of the motion may include determining that motion occurs on a first surface of the electronic device if the value representing the amplitude of the first value associated with the maximum second value is positive, and determining that motion occurs on a second surface of the electronic device opposite to the first surface if the value representing the amplitude of the first value associated with the maximum second value is negative.

In one embodiment, the difference between the times corresponding to those second values may indicate the difference between times represented by the first values corresponding to the second values.

In one embodiment, identifying characteristics of the motion may include determining that one motion has been detected if the difference between the second values that are a relative maximum is greater than or equal to a preset multiple.

In one embodiment, the motion detection method may further include determining, upon receiving the output signal related to a first axis and an output signal related to a second axis in the same time period, the direction in which the electronic device is gripped on the basis of the output signal related to the second axis.

In one embodiment, performing a related function may correspond to at least one of placing or receiving a call, displaying a list of available functions, selecting an item from the list, and executing a specific application in relation to the identified characteristics of the motion.

According to various embodiments of the present disclosure, there is provided a computer-readable storage medium storing a program that, when executed, causes the processor of an electronic device to: obtain first signal data from an output signal of a motion sensor having sensed motion on the electronic device, compute average rates of change between first values of the first signal data, obtain second values by converting the computed average rates of change into absolute values, and identify characteristics of the motion based on the obtained second values. For example, the computer-readable storage medium may be the memory 130 or 230.

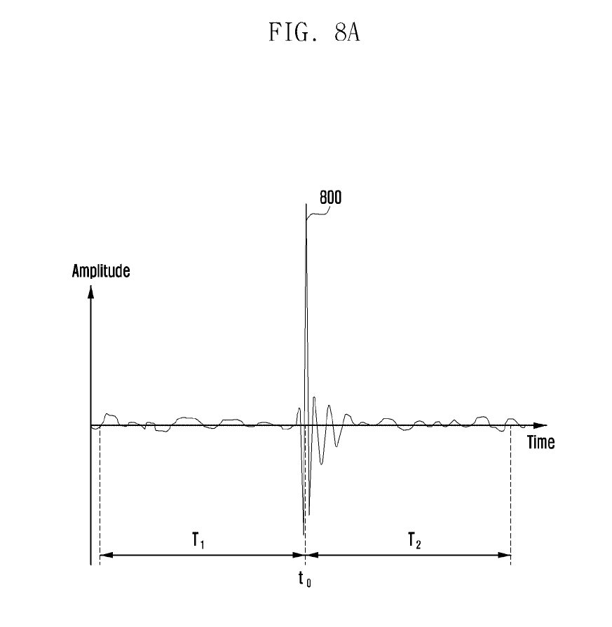

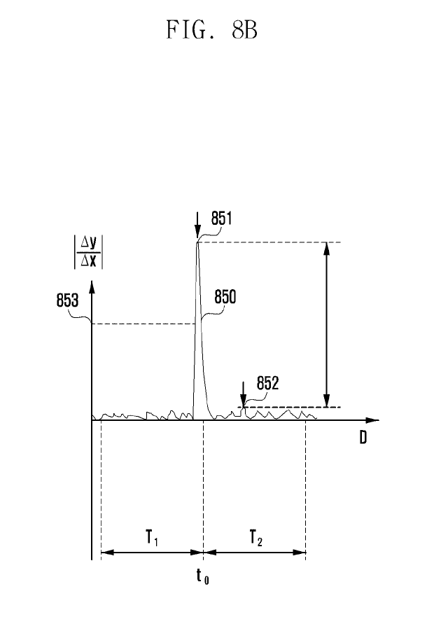

FIG. 8A depicts data corresponding to motion detected by the electronic device according to various embodiments, and FIG. 8B depicts data representing the result of conversion applied to the data shown in FIG. 8A.

As described before, in various embodiments, the electronic device 400 may obtain the first signal data 800 from the output signal of the acceleration sensor 240E. The first signal data 800 may be represented in a graph form as shown in FIG. 8A, where the X-axis represents the time and the Y-axis represents the amplitude. The electronic device 400 may compute average rates of change between first values of the first signal data 800 and obtain second values by converting the computed average rates of change into absolute values. FIG. 8B depicts the graph 850 of the second values, which are absolute values of the average rates of change.

In FIG. 8B, since the second values are associated with multiple first values, the second values of the graph 850 may correspond to the times of the multiple associated first values.

With reference to the graph 850, the electronic device 400 may determine whether there is another second value that is a relative maximum exceeding the threshold within a given interval T₁ before the time t₀ (851) where a second value that is a relative maximum exceeding the threshold has occurred and within a given interval T₂ after the time t₀ (851). The interval may be set by the user.

In one embodiment, if there is no second value that is a relative maximum exceeding the threshold during the interval T₁, the electronic device 400 may recognize the motion detected by the acceleration sensor 240E as a single motion. For example, a single motion may be a knock, a click, or a tap.

In another embodiment, if the difference between the largest one and the second largest one among the second values that are a relative maximum is greater than or equal to a preset multiple, the electronic device 400 may recognize the motion detected by the acceleration sensor 240E as a single motion.

In another embodiment, if there is a second value that is a relative maximum exceeding the threshold only during the interval T₁, the electronic device 400 may recognize the motion detected by the acceleration sensor 240E as a single motion.

In various embodiments, the electronic device 400 may set a noise level using second values not belonging to the maximum peak and dynamically set the recognition condition according to the noise level.

In one embodiment, when the noise level is low, the electronic device 400 can set the allowable maximum of the second largest one among the second values to be low.

In another embodiment, the electronic device 400 may set a noise level using the sum or average of second values not belonging to the maximum peak or the sum or average of second values that are a relative maximum.

In another embodiment, the electronic device 400 may increase the recognition rate and prevent erroneous recognition by applying the above embodiments in a concurrent manner.

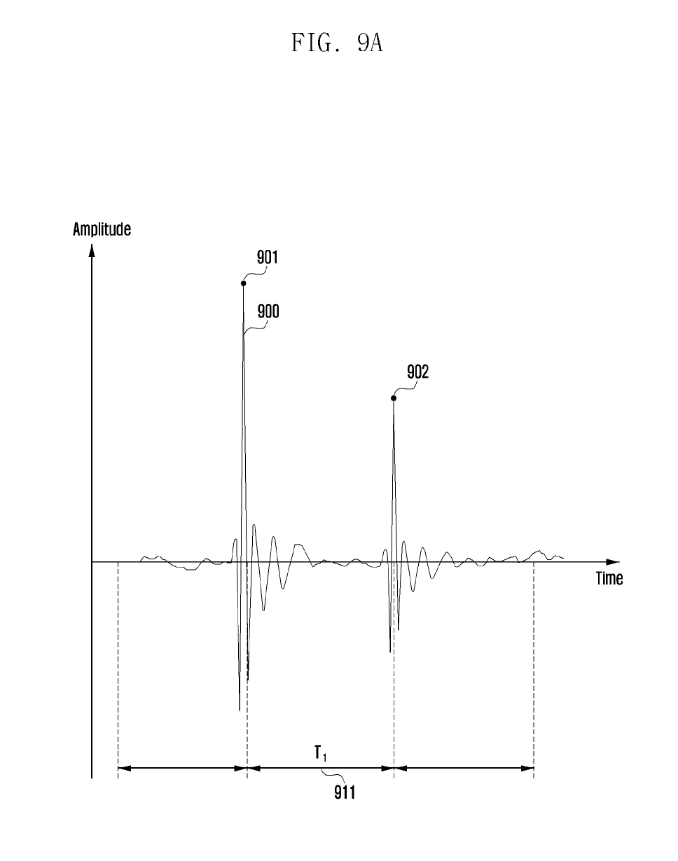

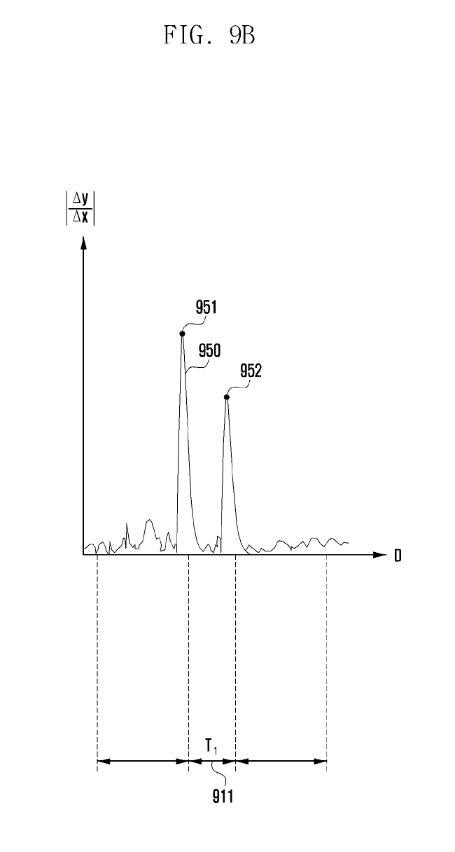

FIG. 9A depicts data corresponding to motion detected by the electronic device according to various embodiments, and FIG. 9B depicts data representing the result of conversion applied to the data shown in FIG. 9A.

As described before, in various embodiments, the electronic device 400 may obtain the first signal data 900 from the output signal of the acceleration sensor 240E. The first signal data 900 may be represented in a graph form as shown in FIG. 9A, where the X-axis represents the time and the Y-axis represents the amplitude. The electronic device 400 may compute average rates of change between first values of the first signal data 900 and obtain second values by converting the computed average rates of change into absolute values. FIG. 8B depicts the graph 950 of the second values, which are absolute values of the average rates of change.

In FIG. 9B, since the second values are associated with multiple first values, the second values of the graph 950 may correspond to the times of the multiple associated first values.

With reference to the graph 950 of second values, if there are two or more second values that are a relative maximum greater than or equal to the threshold (as indicated by indicia 951 and 952) during a given interval T₁ (911), the motion detected by the acceleration sensor 240E may be a continuous motion.

In one embodiment, if there are two or more second values that are a relative maximum greater than or equal to the threshold (as indicated by indicia 951 and 952) during a given interval T₁ (911) and they have the same directionality, the motion detected by the acceleration sensor 240E may be a continuous motion. For example, the continuous motion may be a double motion or triple motion. Examples of a double motion may include a double knock, a double tap, and a double click. Examples of a triple motion may include a triple knock, a triple tap, and a triple click.

In another embodiment, among the second values that are a relative maximum, the largest one and the second largest one are both greater than or equal to the threshold and are within a given interval T₁, the electronic device 400 may recognize the motion detected by the acceleration sensor 240E as a continuous motion. The given interval may be set by the user.

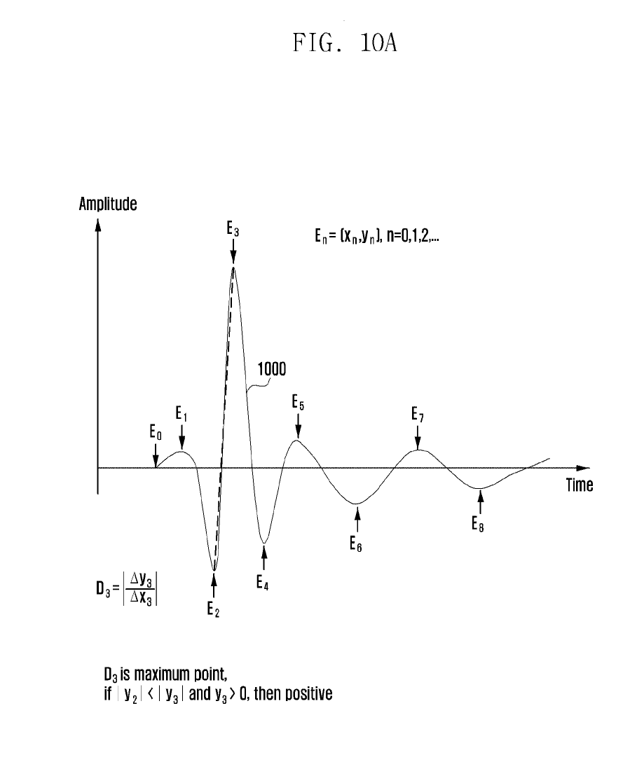

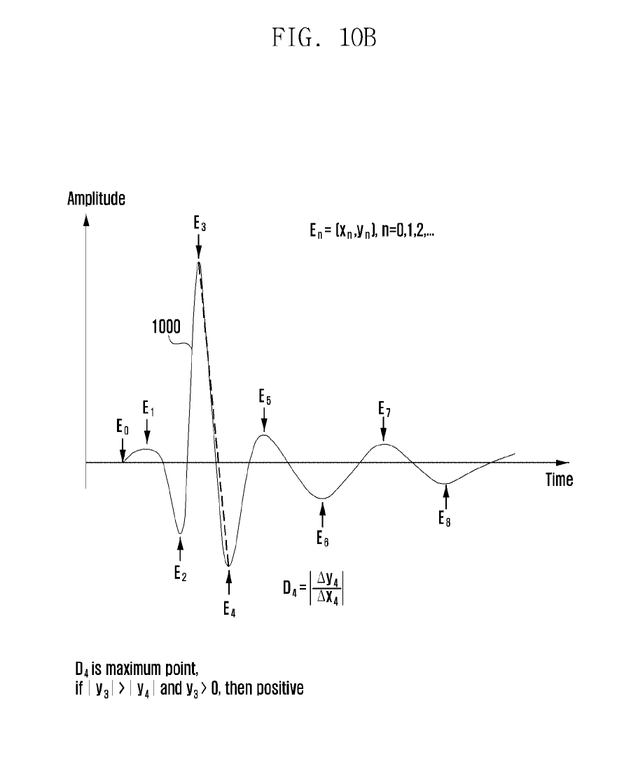

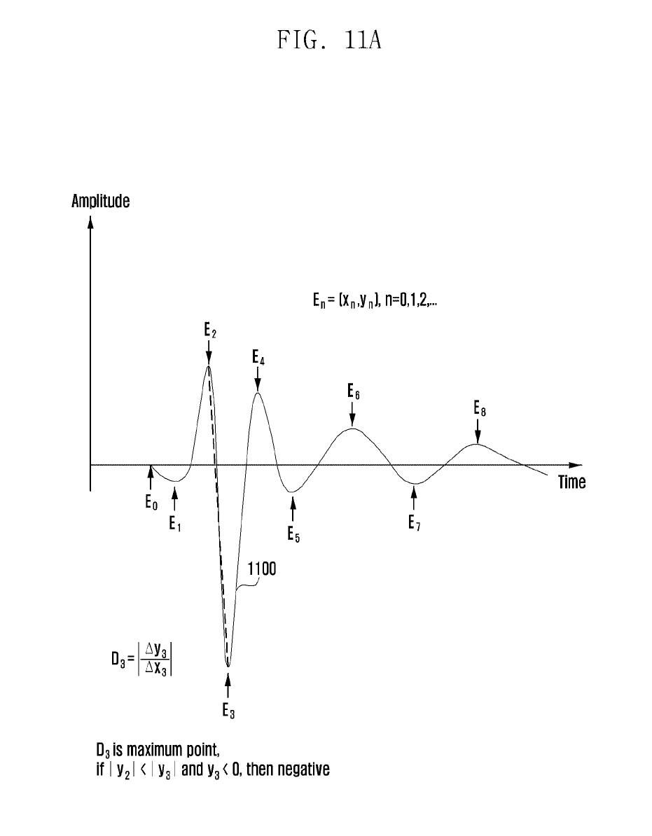

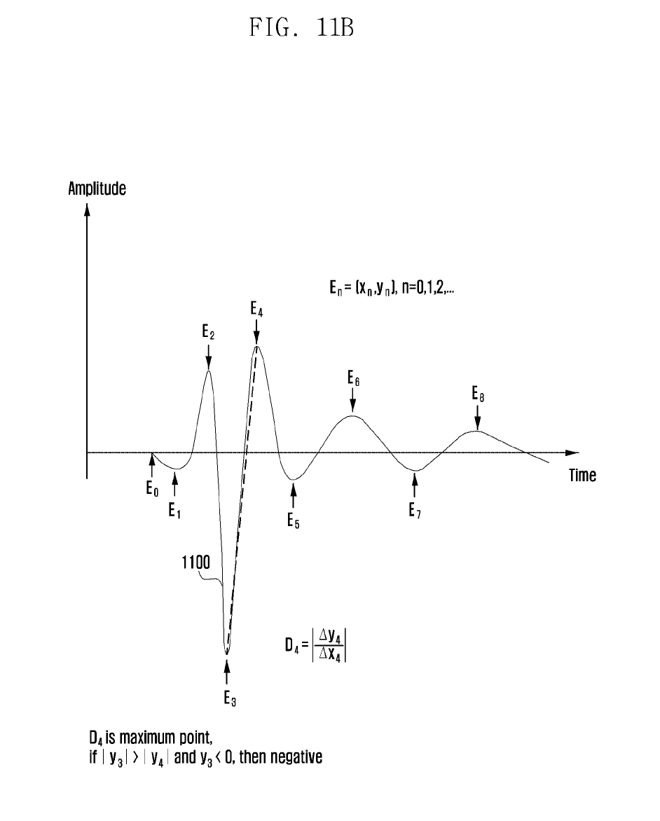

FIGS. 10A to 11B depict data corresponding to motion detected by the electronic device according to various embodiments.

In various embodiments, the electronic device 400 may receive different signals from the acceleration sensor 240E depending on whether the user has applied motion to the back or front of the electronic device 400.

The first signal data 1000 may be represented in a graph form as shown in FIG. 10A, where the X-axis represents the time and the Y-axis represents the amplitude. The electronic device 400 may compute average rates of change between first values of the first signal data 1000 and obtain second values by converting the computed average rates of change into absolute values. The first values may be indicated by E₀ to E₈, and may include extreme points. The value of Eₙ may be given by (xₙ, yₙ) (n=0 . . . 8). The second values may be indicated by Dₙ (n=1 . . . 8).

The electronic device 400 may find the largest one among the second values and compare absolute values of the Y-axis values of the first values associated with the largest second value. Based on the comparison result, the electronic device 400 may determine whether the motion has been applied to the front or the back thereof. This can be represented by Equation 3 below. Here, Dₙ indicates the largest second value.

if |yₙ₋₁|<|yₙ| and yₙ>0, then positive

if |yₙ₋₁|>|yₙ| and yₙ₋₁>0, then positive

if |yₙ₋₁|<|yₙ| and yₙ>0, then negative

if |yₙ₋₁|>|yₙ| and yₙ₋₁>0, then negative Equation 3

In Equation 3, “positive” and “negative” can represent the back and the front, respectively, or can indicate the front and the back, respectively.

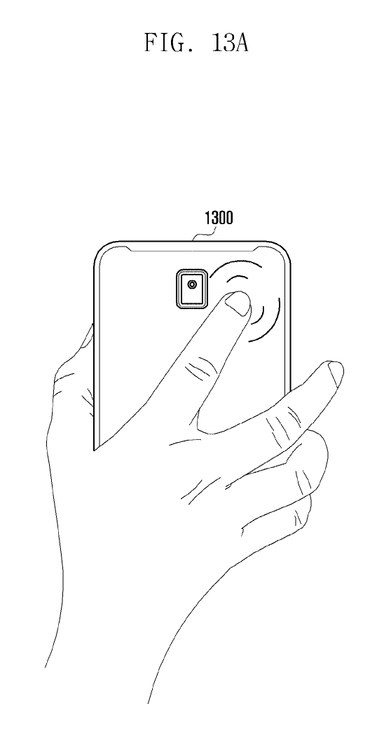

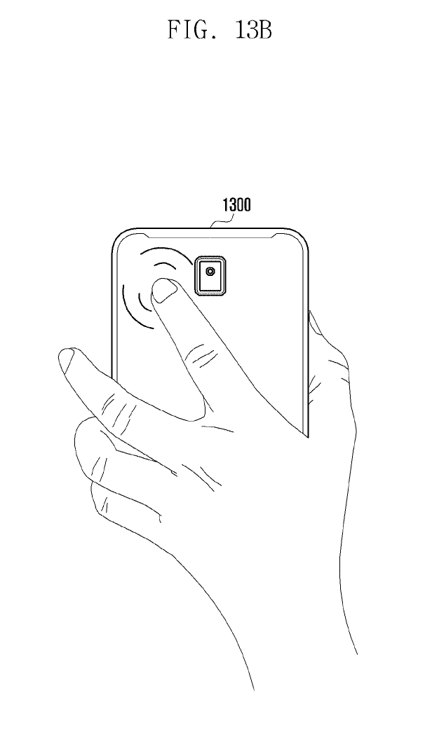

Next, a description is given of a case where the user applies motion to the back (positive) of the electronic device 400 with reference to FIGS. 13A and 13B.

FIGS. 13A and 13B illustrate motion detection on the electronic device according to various embodiments.

As shown in FIGS. 13A and 13B, the user may grip the electronic device 1300 with one hand and apply motion to the back of the electronic device 1300.

In one embodiment, the electronic device 1300 may obtain first signal data 1000 as shown in FIG. 10A. After calculating the second values based on the first signal data 1000, the largest value among the second values may be represented by D₃, which may be the absolute value of the average rate of change between the first values E₂ and E₃. The electronic device 1300 may compare the absolute value of y₂ with the absolute value of y₃. If the absolute value of y₃ is greater than the absolute value of y₂ and y₃ is positive, the electronic device 1300 may determine that the user has applied motion to the back of the electronic device 1300 while gripping the electronic device 1300 with one hand.

In another embodiment, the electronic device 1300 may obtain first signal data 1000 as shown in FIG. 10B. After calculating the second values based on the first signal data 1000, the largest value among the second values may be represented by D₄, which may be the absolute value of the average rate of change between the first values E₃ and E₄. The electronic device 1300 may compare the absolute value of y₃ with the absolute value of y₄. If the absolute value of y₃ is greater than the absolute value of y₄ and y₃ is positive, the electronic device 1300 may determine that the user has applied motion to the back of the electronic device 1300 while gripping the electronic device 1300 with one hand.

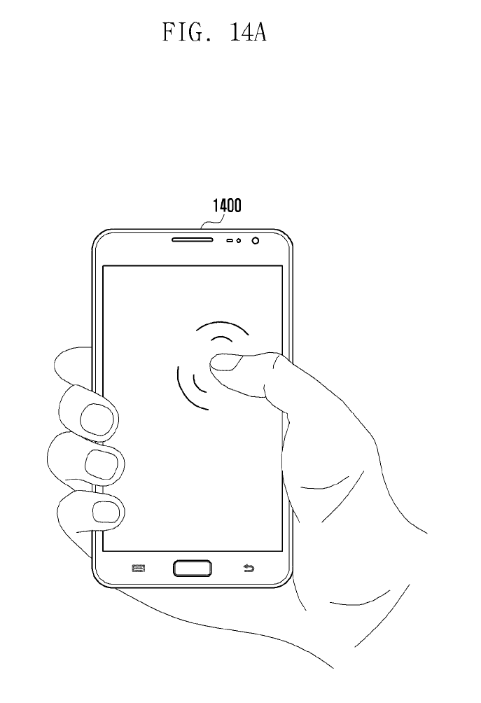

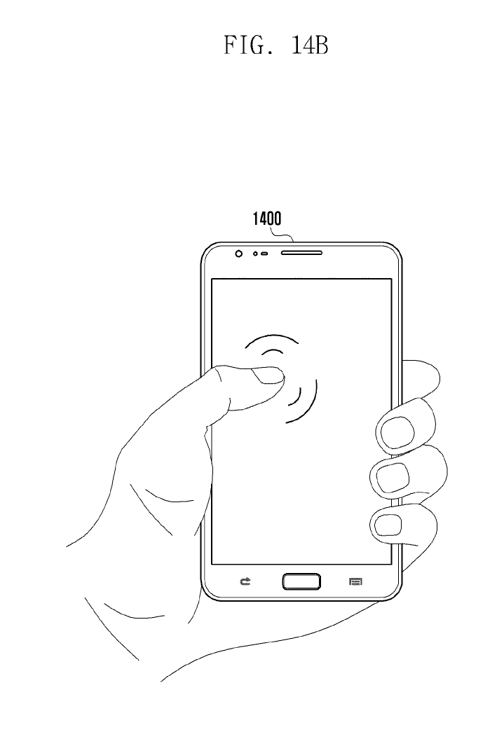

Next, a description is given of a case where the user applies motion to the front (positive) of the electronic device 400 with reference to FIGS. 14A and 14B.

FIGS. 14A and 14B illustrate motion detection on the electronic device according to various embodiments.

As shown in FIGS. 14A and 14B, the user may grip the electronic device 1400 with one hand and apply motion to the front of the electronic device 1400.

In one embodiment, the electronic device 1400 may obtain first signal data 1100 as shown in FIG. 11A. After calculating the second values based on the first signal data 1100, the largest value among the second values may be represented by D₃, which may be the absolute value of the average rate of change between the first values E₂ and E₃. The electronic device 1400 may compare the absolute value of y₂ with the absolute value of y₃. If the absolute value of y₃ is greater than the absolute value of y₂ and y₃ is negative, the electronic device 1400 may determine that the user has applied motion to the front of the electronic device 1400 while gripping the electronic device 1400 with one hand.

In another embodiment, the electronic device 1400 may obtain first signal data 1100 as shown in FIG. 11B. After calculating the second values based on the first signal data 1100, the largest value among the second values may be represented by D₄, which may be the absolute value of the average rate of change between the first values E₃ and E₄. The electronic device 1400 may compare the absolute value of y₃ with the absolute value of y₄. If the absolute value of y₃ is greater than the absolute value of y₄ and y₃ is negative, the electronic device 1400 may determine that the user has applied motion to the front of the electronic device 1400 while gripping the electronic device 1400 with one hand.

FIG. 12 depicts data corresponding to motion detected by the electronic device according to various embodiments.

The acceleration sensor 240E of the electronic device 400 may produce impact data along multiple axes at the same time or within an error range. The electronic device 400 can receive Z-axis data having a value greater than that of other axis data from the acceleration sensor 240E. The electronic device 400 can determine the direction in which the electronic device 400 is gripped on the basis of data of another axis (e.g., X axis) sensed in the same time duration when the Z-axis impact data is sensed. As another example, the electronic device 400 can determine whether the hand gripping the electronic device 400 is the right hand or the left hand.

With reference to FIG. 12, when the user grips the electronic device 400 with either the right hand or the left hand and applies motion to the electronic device 400, the electronic device 400 may receive Z-axis data and X-axis data having a value relatively smaller than that of the Z-axis data from the acceleration sensor 240E.

As described before in the previous embodiments, the Z-axis data may have different types of graphs according to the motion applied to the front or the back of the electronic device 400. The X-axis data may have different types of graphs according to whether the hand gripping the electronic device 400 is the right hand or the left hand.

In various embodiments, the process of determining the direction in which the electronic device 400 is gripped based on the X-axis data may be similar to the process of determining whether the motion is applied to the front or the back of the electronic device 400 based on the Z-axis data.

In various embodiments, the electronic device 400 may identify the characteristics of the motion detected by the motion sensor and perform various functions according to the identified characteristics. Depending on the state of the electronic device 400, the functionality associated with the identified characteristics may vary. Next, a description is given of various functions performed by the electronic device 400.

Examples of the call function of the electronic device 400 are described below.

In one embodiment, the electronic device 400 receiving a call may receive a signal related to motion detected by the motion sensor. The electronic device 400 may identify the characteristics of the motion based on the received signal. For example, if the motion characteristics indicate a double knock, the electronic device 400 may perform call establishment in response to the double knock. As another example, if the motion characteristics indicate a double knock with the electronic device 400 turned over, the electronic device 400 may reject the call in response to the double knock with device reversal.

In one embodiment, the electronic device 400 processing a call may receive a signal related to motion detected by the motion sensor. The electronic device 400 may identify the characteristics of the motion based on the received signal. For example, if the motion characteristics indicate a double knock, the electronic device 400 may terminate the call in response to the double knock. As another example, if the motion characteristics indicate a double knock with the electronic device 400 turned over, the electronic device 400 may terminate the call in response to the double knock with device reversal. As another example, if the motion characteristics indicate a double knock, the electronic device 400 may record the call in response to the double knock.

In one embodiment, the electronic device 400 processing a call may receive another call and receive a signal related to motion detected by the motion sensor. The electronic device 400 may identify the characteristics of the motion based on the received signal. For example, if the motion characteristics indicate a double knock, the electronic device 400 may perform a call transfer function in response to the double knock.

Examples of the launcher function of the electronic device 400 are described below.

In one embodiment, the electronic device 400 in the off state (e.g., screen-off state or sleep state) or in the idle state may receive a signal related to motion detected by the motion sensor. The electronic device 400 may identify the characteristics of the motion based on the received signal. For example, if the motion characteristics indicate a double knock occurring on the back of the electronic device 400, the electronic device 400 may display a launcher menu in response to the double knock. Here, the focus may be displayed on the topmost item of the launcher menu.

In one embodiment, the electronic device 400 displaying the launcher menu may receive a signal related to motion detected by the motion sensor. The electronic device 400 may identify the characteristics of the motion based on the received signal. For example, if the motion characteristics indicate a single knock occurring on the back of the electronic device 400, the electronic device 400 may move the focus from the topmost item of the launcher menu to the bottommost item in response to the single knock.

In one embodiment, the electronic device 400 displaying the launcher menu may receive a signal related to motion detected by the motion sensor. The electronic device 400 may identify the characteristics of the motion based on the received signal. For example, if the motion characteristics indicate a double knock occurring on the back of the electronic device 400, the electronic device 400 may perform a function associated with the focused item (or display a submenu associated with the focused item) in response to the double knock.

In one embodiment, the launcher menu may include menu items associated with flash on/off, recent calls, speech recognition, recently executed applications, music playback, DMB watching, message browsing, camera activation, and favorite applications. The order of the menu items may be set by the user, set in the order of recently executed functions, or set by a combination thereof.

In one embodiment, the launcher menu may include menu items associated with recommendation functions on the basis of the current state and surroundings of the electronic device 400.

In one embodiment, when the brightness is less than a preset level based on the signal received from the illuminance sensor, the electronic device 400 may display a menu item associated with the flash on/off function on the launcher menu.

In one embodiment, upon detecting connection of a Bluetooth headset or earphone, the electronic device 400 may display a menu item associated with the music playback function on the launcher menu.

In one embodiment, when a mirroring capable external device is found, the electronic device 400 may display a menu item associated with the mirroring function on the launcher menu. Mirroring is a technique enabling the contents displayed on the electronic device 400 to be displayed on another device in the vicinity.

In one embodiment, upon determining that the speed is above a certain level based on the data received from the GPS sensor, the electronic device 400 may display a menu item associated with the navigation or map application on the launcher menu.

In one embodiment, when a missed call or unread message is found, the electronic device 400 may display a menu item associated with the function for checking missed calls or unread messages on the launcher menu.

In another embodiment, when an item associated with the recent call function is selected on the launcher menu, the electronic device 400 may display a list of recent calls. The recent call list may be displayed as a popup. The electronic device 400 displaying the recent call list may receive a signal related to the motion detected by the motion sensor. The electronic device 400 may identify the characteristics of the motion based on the received signal. For example, if the motion characteristics indicate a single knock occurring on the back of the electronic device 400, the electronic device 400 may move the focus on the recent call list. Thereafter, upon detecting a double knock occurring on the back of the electronic device 400, the electronic device 400 may place a call to the focused contact of the recent call list.

In various embodiments, the electronic device 400 may receive a first signal related to the motion detected by the motion sensor. The electronic device 400 may identify the characteristics of the motion based on the received first signal. If the motion characteristics indicate a double knock occurring on the electronic device 400 gripped by the user with the right hand, the electronic device 400 may display the launcher menu. The electronic device 400 displaying the launcher menu may receive a second signal related to the motion detected by the motion sensor. The electronic device 400 may identify the characteristics of the motion based on the received second signal. If the motion characteristics indicate a single knock occurring on the right side of the electronic device 400, the electronic device 400 may move the focus to the previous item on the launcher menu.

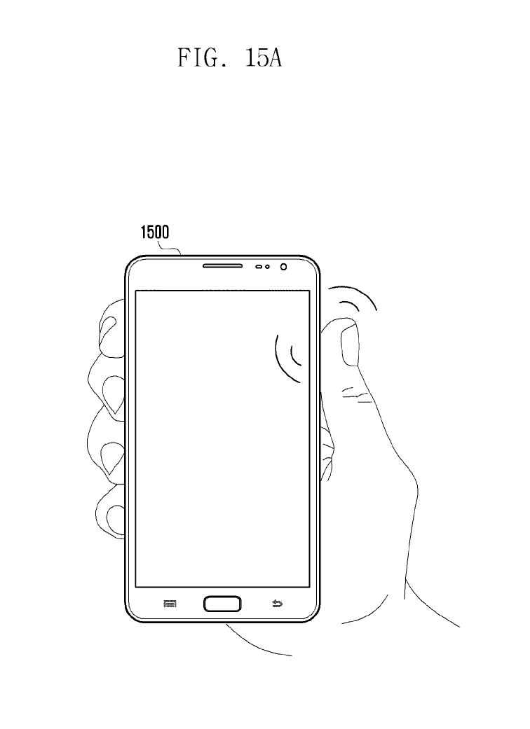

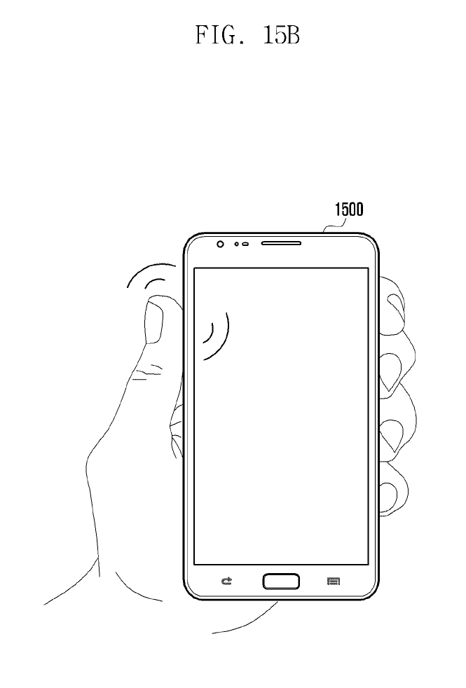

FIGS. 15A and 15B illustrate motion detection on the electronic device according to various embodiments.

As shown in FIGS. 15A and 15B, the user may grip the electronic device 1500 with one hand (e.g., right hand or left hand) and apply motion to one side (e.g., right side or left side) of the electronic device 1500 with a finger (e.g., thumb). Here, the right side or left side of the electronic device 1500 may be determined with respect to the direction in which the front of the electronic device 1500 is viewed (e.g., the direction in which the camera and the display are exposed) as shown in FIGS. 15A and 15B.

In various embodiments, the electronic device 1500 may receive a signal related to motion detected by the motion sensor. For example, the detected motion may correspond to a single knock occurring on the right side or left side of the electronic device 1500. The detected motion may correspond to a double knock occurring on the right side or left side of the electronic device 1500.

The electronic device 1500 may identify the characteristics of the motion based on the received signal.

In one embodiment, if the motion characteristics indicate a double knock occurring on the left side of the electronic device 1500 gripped by the user with the left hand (as shown in FIG. 15B), the electronic device 1500 may perform a first function (e.g., display the launcher menu) in response to the double knock on the left side.

In another embodiment, if the motion characteristics indicate a single knock occurring on the right side of the electronic device 1500 gripped by the user with the right hand (as shown in FIG. 15A), the electronic device 1500 may perform a second function (e.g., move the focus to the previous item) in response to the single knock on the right side.

In various embodiments, the acceleration sensor 240E of the electronic device 400 may produce impact data along multiple axes at the same time or within an error range. The electronic device 400 can receive X-axis data having a value greater than that of other axis data from the acceleration sensor 240E. The electronic device 400 can determine whether the motion is applied to the left side or the right side of the electronic device 400 on the basis of the X-axis data.

In another embodiment, the electronic device 400 can identify additional characteristics of the motion on the basis of both the X-axis data and data of another axis (e.g., Z or Y axis) sensed in the same time duration when the X-axis impact data is sensed.

In various embodiments, the characteristics of motion can be utilized as a means for unlocking the electronic device 400.

In one embodiment, to place a lock, the electronic device 400 may store the characteristics of the motion applied by the user as a password. For example, the electronic device 400 may receive a signal related to motion detected by the motion sensor. Based on the received signal, the electronic device 400 may recognize a single knock occurring at the upper end or lower end of the back of the electronic device 400 gripped by the user with the left hand. The electronic device 400 may store (or set) the single knock caused by the left hand at the upper end or lower end of the back as a password for unlocking. In the locked state, the electronic device 400 may receive a signal related to motion detected by the motion sensor. If the motion characteristics based on the received signal are identical to the stored password characteristics, the electronic device 400 may release the lock.

In various embodiments, the electronic device 400 playing a song and/or video may receive a signal related to motion detected by the motion sensor. The electronic device 400 may identify the characteristics of the motion based on the received signal. For example, if the motion characteristics indicate a single knock occurring on the right side of the electronic device 400, the electronic device 400 may play the next song and/or video. If the motion characteristics indicate a single knock occurring on the left side of the electronic device 400, the electronic device 400 may play the previous song and/or video. If the motion characteristics indicate a double knock occurring on the back of the electronic device 400, the electronic device 400 may start or pause playback of the song and/or video. If the motion characteristics indicate a triple knock occurring on the back of the electronic device 400 playing a video, the electronic device 400 may transition to the full screen mode.

In various embodiments, the electronic device 400 in the photograph or video mode may receive a signal related to motion detected by the motion sensor. The electronic device 400 may identify the characteristics of the motion based on the received signal. For example, if the motion characteristics indicate a single or double knock occurring on the back of the electronic device 400, the electronic device 400 may take a photograph or video.

In various embodiments, the electronic device 400 displaying a captured image may receive a signal related to motion detected by the motion sensor. The electronic device 400 may identify the characteristics of the motion based on the received signal. For example, if the motion characteristics indicate a single or double knock occurring on the back of the electronic device 400 being turned over, the electronic device 400 may delete the captured image.

In various embodiments, the electronic device 400 waiting for a selection input from the user may receive a signal related to motion detected by the motion sensor. The electronic device 400 may identify the characteristics of the motion based on the received signal. For example, if the motion characteristics indicate a double knock occurring on the back of the electronic device 400, the electronic device 400 may recognize the double knock as a positive selection input. Here, the positive selection may correspond to selecting “yes”, “OK”, “next”, or “accept”. As another example, if the motion characteristics indicate a double knock occurring on the back of the electronic device 400 being turned over, the electronic device 400 may recognize the double knock as a negative selection input. Here, the negative selection may correspond to selecting “no”, “cancel”, “previous”, or “reject”. To wait for a selection input, the electronic device 400 may display a popup window including selection items labeled “accept” and “reject”.

In various embodiments, the electronic device 400 may receive a signal related to motion detected by the motion sensor, identify the motion based on the received signal, and use the identified motion as a virtual key input. For example, the electronic device 400 may transfer the key input to the currently running application, which may perform a function corresponding to the key input. Such a virtual key input may also be applied to third party applications.

In various embodiments, the electronic device 400 may receive a signal related to motion detected by the motion sensor and identify the characteristics of the motion based on the received signal. In particular, the electronic device may identify the sensitivity of the motion. For example, upon recognizing a double knock occurring on the back of the electronic device 400, the electronic device 400 may perform different functions according to the strength, direction, occurrence time, interval between knocks of the double knock.

In various embodiments, the electronic device 400 performing a specific function may receive a signal related to motion detected by the motion sensor, identify the characteristics of the motion based on the received signal, and perform at least one function according to the motion characteristics (e.g., switching between functions, or displaying a screen related to the function). In one embodiment, upon recognizing a double knock occurring on the back of the electronic device 400, the electronic device 400 may transition to the one-handed operation mode. For example, upon recognizing a double knock occurring on the back of the electronic device 400 gripped by the user with the right hand, the electronic device 400 may activate the right-handed operation mode. Upon recognizing a double knock occurring on the back of the electronic device 400 gripped by the user with the left hand, the electronic device 400 may activate the left-handed operation mode. During the one-handed operation mode (right-handed operation or left-handed operation), to receive user input, the electronic device 400 may output the user interface on the display in a right-shifted or left-shifted form.

As described above, the electronic device according to various embodiments of the present disclosure may include: a sensor module including a motion sensor configured to detect motion on the electronic device; a processor configured to receive an output signal from the motion sensor; and a memory electrically connected to the processor. The memory may store instructions that, when executed, cause the processor to: obtain first signal data from the output signal of the motion sensor; compute average rates of change between first values of the first signal data; obtain second values by converting the computed average rates of change into absolute values; and identify characteristics of the motion based on the obtained second values.

In one embodiment, the memory may further store instructions that cause the processor to perform a function related to the identified characteristics of the motion.

In one embodiment, the output signal of the motion sensor may include an output signal associated with one of one or more axes of an acceleration sensor.

In one embodiment, the memory may store instructions that cause the processor to: sample the output signal; determine whether the sampling period of the output signal is constant; resample the output signal by use of interpolation if the sampling period is not constant; and filter the resampled output signal to obtain the first signal data.

In one embodiment, the memory may store instructions that cause the processor to filter the sampled output signal to obtain the first signal data if the sampling period is constant.

In one embodiment, the memory may store instructions that cause the processor to perform filtering using at least one of a high pass filter (HPF) and a band pass filter (BPF).

In one embodiment, the first values may include one of a relative maximum greater than nearby values and a relative minimum less than nearby values among the values of the first signal data.

In one embodiment, each first value may include a time value and an amplitude value.

In one embodiment, the memory may store instructions that cause the processor to determine the number of occurrences of motion on the basis of the number of second values that are a relative maximum greater than or equal to a preset threshold.

In one embodiment, the memory may store instructions that cause the processor to: determine, if there are multiple second values that are a relative maximum greater than or equal to the threshold and the difference between the times corresponding to those second values is within a preset duration, the directions of the motion; and determine that a plurality of motions have been detected if the directions are identical.

In one embodiment, the memory may store instructions that cause the processor to: determine that motion occurs on a first surface of the electronic device if the amplitude of the first value associated with the maximum second value is positive; and determine that motion occurs on a second surface of the electronic device opposite to the first surface if the amplitude of the first value associated with the maximum second value is negative.

In one embodiment, the difference between the times corresponding to multiple second values may indicate the difference between times represented by the first values corresponding to the multiple second values.

In one embodiment, the memory may store instructions that cause the processor to determine that one motion has been detected if the difference between the second values that are a relative maximum is greater than or equal to a preset multiple.

In one embodiment, the memory may store instructions that cause the processor to determine, upon receiving the output signal related to a first axis and an output signal related to a second axis in the same time period, the direction in which the electronic device is gripped on the basis of the output signal related to the second axis.

In one embodiment, the related function may correspond to at least one of placing or receiving a call, displaying a list of available functions, selecting an item from the list, and executing a specific application in relation to the identified characteristics of the motion.

As described hereinabove, in a feature of the present disclosure, the motion detection method enables the electronic device 400 to detect motion even in a practical usage environment. As a result, the electronic device 400 may detect various motions of the user by use of a motion sensor, enabling the user to execute various functions in a more convenient manner.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a sensor module including a motion sensor configured to detect motion on the electronic device;
a memory; and
a processor configured to:
receive an output signal from the motion sensor;
obtain first signal data from the received output signal;
compute average rates of change between first values of the first signal data;
obtain second values by converting the computed average rates of change into absolute values; and
identify characteristics of the motion based on the obtained second values.

2. The electronic device of claim 1, wherein the output signal of the motion sensor includes an output signal associated with one of one or more axes of an acceleration sensor.

3. The electronic device of claim 2, wherein, upon receiving an output signal related to a first axis and an output signal related to a second axis in a same time period, the processor is configured to determine a direction in which the electronic device is gripped on the basis of the output signal related to the second axis.

4. The electronic device of claim 1, wherein the processor is configured to:
sample the output signal;
determine whether a sampling period of the output signal is constant;
if the sampling period is constant, filter the sampled output signal to obtain the first signal data; and
if the sampling period is not constant, resample the output signal by use of interpolation and filter the resampled output signal to obtain the first signal data.

5. The electronic device of claim 4, wherein the processor is configured to perform filtering using at least one of a high pass filter (HPF) or a band pass filter (BPF).

6. The electronic device of claim 1, wherein:
each first value indicates time and amplitude, and
the first values include one of a relative maximum greater than nearby values and a relative minimum less than nearby values among the values of the first signal data.

7. The electronic device of claim 1, wherein the processor is configured to determine a number of occurrences of motion on the basis of a number of second values that are a relative maximum greater than or equal to a preset threshold.

8. The electronic device of claim 7, wherein, if there are multiple second values that are (i) a relative maximum greater than or equal to the preset threshold and (ii) a difference between the times corresponding to those second values is within a preset duration, the processor is configured to examine directions of the motion and determine that a plurality of motions have been detected if the directions are identical.

9. The electronic device of claim 8, wherein the processor is configured to:
determine that motion occurs on a first surface of the electronic device if an amplitude of the first value associated with the maximum second value is positive; and
determine that motion occurs on a second surface of the electronic device opposite to the first surface if the amplitude of the first value associated with the maximum second value is negative.

10. The electronic device of claim 8, wherein the difference between the times corresponding to multiple second values includes the difference between the times represented by the first values corresponding to the multiple second values.

11. The electronic device of claim 1, wherein the processor is configured to determine that one motion has been detected if the difference between the second values that are a relative maximum is greater than or equal to a preset multiple.

12. The electronic device of claim 1, wherein:
the processor is configured to execute a function related to the identified motion characteristics, and
wherein the related function corresponds to at least one of placing a call, receiving a call, displaying a list of available functions, selecting an item from the list, or executing a specific application in relation to the identified motion characteristics.

13. A method of motion detection for an electronic device, the method comprising:
obtaining first signal data from an output signal of a motion sensor having sensed motion on the electronic device;
computing average rates of change between first values of the first signal data;
obtaining second values by converting the computed average rates of change into absolute values; and
identifying characteristics of the motion based on the obtained second values.

14. The method of claim 13, further comprising performing a function related to the identified motion characteristics.

15. The method of claim 13, wherein obtaining first signal data comprises:
sampling the output signal;
determining whether a sampling period of the output signal is constant;
if the sampling period is constant, filtering the sampled output signal to obtain the first signal data; and
if the sampling period is not constant, resampling the output signal by use of interpolation and filtering the resampled output signal to obtain the first signal data.

16. The method of claim 13, wherein:
each first value indicates time and amplitude, and
the first values include one of a relative maximum greater than nearby values and a relative minimum less than nearby values among the values of the first signal data.

17. The method of claim 13, wherein identifying characteristics of the motion comprises determining a number of occurrences of motion on the basis of a number of second values that are a relative maximum greater than or equal to a preset threshold.

18. The method of claim 17, wherein:
if there are multiple second values that are (i) a relative maximum greater than or equal to the preset threshold and (ii) a difference between times corresponding to those second values is within a preset duration, identifying characteristics of the motion comprises examining directions of the motion and determining that a plurality of motions have been detected if the directions are identical, and
the difference between the times corresponding to multiple second values includes the difference between the times represented by the first values corresponding to the multiple second values.

19. The method of claim 18, wherein examining the directions of the motion comprises:
determining that motion occurs on a first surface of the electronic device if an amplitude of the first value associated with the maximum second value is positive; and
determining that motion occurs on a second surface of the electronic device opposite to the first surface if the amplitude of the first value associated with the maximum second value is negative.

20. The method of claim 18, wherein identifying characteristics of the motion comprises determining that one motion has been detected if a difference between the second values that are a relative maximum is greater than or equal to a preset multiple.
